(19) United States
(12) Patent Application Publication
(10) Pub. No.: US 2020/0017636 A1
(43) Pub. Date: Jan. 16, 2020

(54) SHORT DIAMINE-BASED SEMI-CRYSTALLINE POLYAMIDE COMPOSITION HAVING A HIGH GLASS TRANSITION TEMPERATURE FOR A THERMOPLASTIC MATERIAL, PRODUCTION METHOD THEREOF AND USES OF SAME

(71) Applicant: Arkeme France, Colombes (FR)

(72) Inventors: Mathieu Y. CAPELOT, Bernay (FR); Gilles HOCHSTETTER, L'Hay Les Roses (FR)

(21) Appl. No.: 16/492,959

(22) PCT Filed: Mar. 23, 2018
(86) PCT No.: PCT/FR2018/050711

§ 371 Date: Sep. 11, 2019

(30) Foreign Application Priority Data
Mar. 24, 2017 (FR) 1752486
May 22, 2017 (FR) 1754508

(51) Int. Cl. C08G 69/26; C08L 77/06; C08J 5/00; B29C 45/00

(52) U.S. Cl. CPC C08G 69/265; C08L 77/06; C08J 5/005; B29K 2077/00; C08J 2377/06; C08L 2205/16; B29C 45/0005

(57) ABSTRACT

The invention relates to a composition for a thermoplastic material comprising:
0 to 70% by weight, preferably 20 to 60% by weight, of short reinforcing fibers,
30 to 1000% by weight, preferably 40 to 80% by weight, of a thermoplastic matrix based on at least one semi-crystalline polyamide polymer,
0 to 50% of additives and/or other polymers,
   said semi-crystalline polyamide polymer being:
a) a reactive composition comprising or consisting of at least one reactive precursor polyamide prepolymer of said semi-crystalline polyamide polymer,
or as an alternative to a),
b) a non-reactive composition of at least one polyamide polymer, said composition being that of the thermoplastic matrix defined above,
   and said reactive polyamide prepolymer of composition a) and said polyamide polymer of composition b) comprising or consisting of at least one BACT/XT copolyamide.

The invention relates to a novel semi-crystalline (sc) polyamide composition with a high glass transition temperature, containing bis(aminomethyl)cyclohexane (BAC), for a thermoplastic material.

It also relates to the production method for said thermoplastic material and to uses of said composition for the manufacturing of mechanical parts or structured parts containing said material for material parts and the resulting part and for applications in the domains of: automotive, rail, marine, road transport, wind, sport, space and aeronautics, construction, signs and leisure and electrical and electronics.

A major challenge in materials is to find a polyamide resin meeting the following specifications:
High Tg for a wide range of service temperatures;
High Tm for good hold at temperature but sufficiently low to be processable, in particular by injection;
Very good crystallization capacity for rapid demolding and therefore for compatibility with intensive production cycles, for example such as those used in the automotive industry;
High rigidity, including when hot, for being able to obtain the highest moduli possible for the final material.

Document CN 104211953 describes a polyamide composition comprising from 30 to 99.9% by weight of a polyamide resin comprising from 60 to 95 mol % of 10 T, from 5 to 40 mol % of 5′T, 5′ corresponding to 2-methyl-1,5-pentamethylenediamine, from 0 to 70% by weight of a strengthening filler and from 0.1 to 50% by weight of an additive.

The polyamide resin has a melting temperature greater than 260° C. and high molar proportions of 10 T.

EP 550 314 describes, among its examples, copolyamide compositions (non-reactive) by seeking melting temperatures greater than 250° C. and limited Tg with the majority of examples cited having too low a Tg (<80° C.).

EP 1 988 113 describes molding compositions containing a 10 T/6 T copolyamide with:
40 to 95% mol of 10 T
5 to 40% of 6 T.

Specific targets include polyamides with high melting temperature greater than 270° C.

WO 2011/003973 describes compositions comprising from 50 to 95 mol % of a motif containing a linear aliphatic diamine including from 9 to 12 carbon atoms and terephthalic acid and from 5 to 50% of motif combining terephthalic acid with a mixture of 2,2,4 and 2,4,4 trimethylhexanediamine.

WO 2014/064375 describes in particular a PA MXDT/10 T that has an excellent compromise between the diverse characteristics described above. Unfortunately, the meta-xylenediamine (MXD) monomer used is greatly prone to secondary reactions, in particular leading to the formations of branches.

The drawbacks of the state of the art, with the absence of a good compromise between mechanical performances and easy implementation (ease of transformation) with a shorter production cycle time are overcome by the solution of the present invention which targets compositions of semi-crystalline PA, with an excellent compromise between high mechanical performances (mechanical hold) particularly when hot and easy implementation. It is indeed high rigidity and has a glass transition temperature >130° C., a Tm of 290° C. to 340° C., and excellent ability to crystallize (Tm−Tc<40° C.), which makes it a matrix of choice for implementation by extrusion, injection or molding, especially for wind, automotive or aeronautics and electrical or electronics.

The choice of a semi-crystalline polyamide polymer, as matrix for the thermoplastic material of the invention, is, relative to amorphous polyamides, of interest for significantly improved mechanical performances in particular when hot, such as creep strength and fatigue resistance. In addition, having a melting point above 200° C. has the advantage in automotive of being compatible with cataphoresis treatments, which do not allow for amorphous PA structures. A target Tg greater than or equal to 130° C. is sought to ensure good mechanical properties for the thermoplastic material over the whole temperature range of use. The crystallinity of said polymer must be as high as possible to optimize mechanical performances and the highest possible crystallization rate and/or crystallization temperature, to reduce the molding time before the molded part is ejected with a selective choice of composition of said semi-crystalline polyamide.

The subject matter of the present invention is the implementation of new specific compositions of thermoplastic material, specifically containing semi-crystalline polyamide, having a good compromise between high mechanical performances (mechanical hold) particularly when hot and easy implementation. More specifically, the solution of the invention, in the case of reactive compositions, by using compositions containing reactive semi-crystalline polyamide prepolymers, allows both improved processability because of the low initial viscosity of the composition, allowing for example the use of lower injection pressures, or the molding of parts with a high level of finesse, but also improved mechanical properties because of the high molecular weights that can be achieved. More particularly, along with a high Tg and a Tm as defined, with easy implementation of said thermoplastic material, the polyamide polymer matrix must also have a high rate of crystallization, characterized first by a difference between the melting and crystallization temperatures Tm−Tc that does not exceed 40° C., preferably not exceeding 30° C. Therefore, the subject matter of the invention is to develop a polyamide composition meeting the needs already defined above:
High Tg for a wide range of service temperatures;
A Tm of 290° C. to 340° C., for easy processing, in particular by injection;
Very good crystallization capacity for rapid demolding and therefore for compatibility with intensive production cycles, for example such as those used in the automotive industry;
High rigidity, including when hot, for being able to obtain the highest moduli possible for the final material.

The present invention relates to a composition for a thermoplastic material comprising:
0 to 70% by weight, preferably 20 to 60% by weight, of short reinforcing fibers,
30 to 100% by weight, preferably 40 to 80% by weight, of a thermoplastic matrix based on at least one semi-crystalline polyamide polymer,
0 to 50% of additives and/or other polymers,
   said semi-crystalline polyamide polymer being:
a) a reactive composition comprising or consisting of, at least one reactive precursor polyamide prepolymer of said semi-crystalline polyamide polymer,
or as an alternative to a),
b) a non-reactive composition of at least one polyamide polymer, said composition being that of the thermoplastic matrix defined above,
   and said reactive polyamide prepolymer of composition a) and said polyamide polymer of composition b) comprising or consisting of at least one BACT/XT copolyamide wherein:
BACT is a unit with an amide motif present at a molar content ranging from 15 to 90%, preferably from 20 to 85%, more preferably from 25 to 80%, where BAC is chosen from among 1,3-bis (aminomethyl) cyclohexane (1,3 BAC), 1,4-bis (aminomethyl) cyclohexyl (1,4 BAC) or a mixture thereof, and T is terephthalic acid,
XT is a unit with an amide motif present at a molar content ranging from 10 to 85%, preferably from 15 to 80%, more preferably from 20 to 75%, where X is a C4 to C8 linear aliphatic diamine, preferably C4, C5, or C6, and where T is terephthalic acid, preferably C6,
in the BACT and/or XT units, independently of each other, up to 30 mol %, preferably 20 mol %, particularly up to 10 mol % of terephthalic acid, relative to the total quantity of dicarboxylic acids, can be replaced by other diaromatic, dialiphatic dicarboxylic acids chosen from adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid and dimerized or cycloaliphatic fatty acids and comprising 6 to 36 carbon atoms, preferably from 6 to 14 carbon atoms, and
in the BACT and/or XT units, independently of each other, up to 30 mol %, preferably 20 mol %, particularly up to 10 mol %, of BAC and/or if applicable X, relative to the total quantity of the diamines, can be replaced by other diamines comprising from 4 to 36 carbon atoms, particularly 6 to 12 carbon atoms, and
in the copolyamide, not more than 30 mol %, preferably not more than 20%, preferably not more than 10 mol %, relative to the total quantity of the monomers, can be formed by lactams or aminocarboxylic acids chosen from α,ω-aminononanoic acid, α,ω-aminoundecanoic acid (AUA), lauryllactam (LL) and α,ω-aminododecanoic acid (ADA), and
provided that the sum of the monomers that replace terephthalic acid, BAC and X does not exceed a concentration of 30 mol %, preferably 20 mol %, preferably 10 mol %, relative to the total quantity of the monomers used in the copolyamide, and
provided that BACT and XT units are still present in said polyamide polymer, and
provided that when X is a C6 linear aliphatic diamine, BACT is present at a molar content ranging from 40 to 90%, preferably from 60 to 90%, and 6 T is present at a molar content ranging from 10 to 60%, preferably from 10 to 40%.

It is clear that the partial replacement of monomers defined above extends to meeting the ranges for BACT and XT defined above, i.e. that when BACT is present for example in proportions of 20 to 70%, any partial replacement of BAC and/or T will lead in all cases to a final proportion of at least 20% of BACT and the same for XT.

Said semi-crystalline polyamide polymer is therefore the semi-crystalline polyamide polymer that forms the basis of the thermoplastic matrix and that can be obtained from the reactive composition a) that corresponds:

either a polyamide prepolymer that terminates in di-NH₂ or di-CO₂H that can react respectively with another polyamide prepolymer that terminates in di-CO₂H or di-NH₂ to lead to said semi-crystalline polyamide polymer,
or a prepolymer that terminates in NH₂ and CO₂H that can react with itself, to lead to said semi-crystalline polyamide polymer,
or a prepolymer that can react or with a chain extender, to lead to said semi-crystalline polyamide polymer,
or the semi-crystalline polyamide polymer is already present in non-reactive composition b).

In other words, the present invention relates to a composition for a thermoplastic material comprising:
0 to 70% by weight, preferably 20 to 60% by weight, of short reinforcing fibers,
30 to 100% by weight, preferably 40 to 80% by weight, of a thermoplastic matrix based on at least one semi-crystalline polyamide polymer,
0 to 50% of additives and/or other polymers,
   said composition being:
a) a reactive composition comprising or consisting of, at least one reactive precursor polyamide prepolymer of said semi-crystalline polyamide polymer,
or as an alternative to a),
b) a non-reactive composition of at least one polyamide polymer, said composition being that of the thermoplastic matrix defined above,
   and said reactive polyamide prepolymer of composition a) and said polyamide polymer of composition b) comprising or being constituted of at least one BACT/XT copolyamide wherein:
BACT is a unit with an amide motif present at a molar content ranging from 15 to 90%, preferably from 20 to 85%, more preferably from 25 to 80%, where BAC is chosen from among 1,3-bis (aminomethyl) cyclohexane (1,3 BAC), 1,4-bis (aminomethyl) cyclohexyl (1,4 BAC) or a mixture thereof, and T is terephthalic acid,
XT is a unit with an amide motif present at a molar content ranging from 10 to 85%, preferably from 15 to 80%, more preferably from 20 to 75%, in particular 45 to 65%, where X is a C4 to C8 linear aliphatic diamine, preferably C4, C5, or C6, and where T is terephthalic acid, preferably C6.
in the BACT and/or XT units, independently of each other, up to 30 mol %, preferably 20 mol %, particularly up to 10 mol % of terephthalic acid, relative to the total quantity of dicarboxylic acids, can be replaced by other diaromatic, dialiphatic dicarboxylic acids chosen from suberic acid, azelaic acid, sebacic acid, undecanedioic acid, dodecanedioic acid, brassylic acid, tetradecanedioic acid, pentadecanedioic acid, hexadecanedioic acid, octadecanedioic acid and dimerized or cycloaliphatic fatty acids comprising 6 to 36 carbon atoms, particularly 6 to 14 carbon atoms, and
in the BACT and/or XT units, independently of each other, up to 30 mol %, preferably 20 mol %, particularly up to 10 mol %, of BAC and/or if applicable X, relative to the total quantity of the diamines, can be replaced by other diamines comprising from 4 to 36 carbon atoms, particularly 6 to 12 carbon atoms, and
in the copolyamide, not more than 30 mol %, preferably not more than 20% preferably not more than 10 mol %, relative to the total quantity of the monomers, can be formed by lactams or aminocarboxylic acids chosen from α,ω-aminononanoic acid, α,ω-aminoundecanoic acid (AUA), lauryllactam (LL) and α,ω-aminododecanoic acid (ADA), and
provided that the sum of the monomers that replace terephthalic acid, BAC and X does not exceed a concentration of 30 mol %, preferably 20 mol %, preferably 10 mol %, relative to the total quantity of the monomers used in the copolyamide, and
provided that BACT and XT units are still present in said polyamide polymer, and
provided that when X is a C6 linear aliphatic diamine, BACT is present at a molar content ranging from 60 to 90%, and 6 T is present at a molar content ranging from 10 to 60%, preferably from 10 to 40%.

The expression “said reactive polyamide prepolymer of composition a) and said polyamide polymer of composition b) comprising or consisting of at least one BACT/XT copolyamide means that the reactive polyamide prepolymer of composition a) or said polyamide polymer of composition b) consist exclusively of units with BACT and XT amide motifs in the respective proportions defined above, i.e. that the reactive polyamide prepolymer of composition a) or said polyamide polymer of composition b) comprise BACT and XT amide motifs in the respective proportions defined above but also other units with amide motifs.

Advantageously, the proportion of BACT and XT amide motif units in the reactive polyamide prepolymer of composition a) or said polyamide polymer of composition b) is greater than 50%, in particular greater than 60%, specifically greater than 70%, preferably greater than 80%, in particular greater than 90%.

Therefore the present invention relates to a composition for a thermoplastic material comprising:
0 to 70% by weight, preferably 20 to 60% by weight, of short reinforcing fibers,
30 to 100% by weight, preferably 40 to 80% by weight, of a thermoplastic matrix based on at least one semi-crystalline polyamide polymer,
0 to 50% of additives and/or other polymers,
   said semi-crystalline polyamide polymer comprising or consisting of at least one BACT/XT copolyamide wherein:
BACT is a unit with an amide motif present at a molar content ranging from 15 to 90%, preferably from 20 to 85%, more preferably from 25 to 80%, where BAC is chosen from among 1,3-bis (aminomethyl) cyclohexane (1,3 BAC), 1,4-bis (aminomethyl) cyclohexyl (1,4 BAC) or a mixture thereof, and T is terephthalic acid,
XT is a unit with an amide motif present at a molar content ranging from 10 to 85%, preferably from 15 to 80%, more preferably from 20 to 75%, in particular 45 to 65%, where X is a C4 to C8 linear aliphatic diamine, preferably C4, C5, or C6, and where T is terephthalic acid, preferably C6.
in the BACT and/or XT units, independently of each other, up to 30 mol %, preferably 20 mol %, particularly up to 10 mol % of terephthalic acid, relative to the total quantity of dicarboxylic acids, can be replaced by other diaromatic, dialiphatic dicarboxylic acids chosen from suberic acid, azelaic acid, sebacic acid, undecanedioic acid, dodecanedioic acid, brassylic acid, tetradecanedioic acid, pentadecanedioic acid, hexadecanedioic acid, octadecanedioic acid and dimerized or cycloaliphatic fatty acids comprising 6 to 36 carbon atoms, particularly 6 to 14 carbon atoms, and
in the BACT and/or XT units, independently of each other, up to 30 mol %, preferably 20 mol %, particularly up to 10 mol %, of BAC and/or if applicable X, relative to the total quantity of the diamines, can be replaced by other diamines comprising from 4 to 36 carbon atoms, particularly 6 to 12 carbon atoms, and
in the copolyamide, not more than 30 mol %, preferably not more than 20% preferably not more than 10 mol %, relative to the total quantity of the monomers, can be formed by lactams or aminocarboxylic acids chosen from α,ω-aminononanoic acid, α,ω-aminoundecanoic acid (AUA), lauryllactam (LL) and α,ω-aminododecanoic acid (ADA), and
provided that the sum of the monomers that replace terephthalic acid, BAC and X does not exceed a concentration of 30 mol %, preferably 20 mol %, preferably 10 mol %, relative to the total quantity of the monomers used in the copolyamide, and
provided that BACT and XT units are still present in said polyamide polymer, and
provided that when X is a C6 linear aliphatic diamine, BACT is present at a molar content ranging from 60 to 90% and 6 T is present at a molar content ranging from 10 to 60%, preferably from 10 to 40%.

The composition according to the invention may include short reinforcing fibers or short strengthening fibers).

Preferably, the “short” fibers are between 200 and 400 μm long.

These short reinforcing fibers may be chosen from:
natural fibers
inorganic fibers, those having high melting temperatures Tm′ greater than the melting temperature Tm of said semi-crystalline polyamide of the invention and greater than the polymerization and/or implementation temperature.
polymer fibers having a melting temperature Tm′ or if not the Tm′, a glass transition temperature Tg′, greater than the polymerization temperature or greater than the melting temperature Tm of said semi-crystalline polyamide constituting said matrix of thermoplastic material and greater than the implementation temperature.
or mixtures of the fibers cited above.

Examples of inorganic fibers suitable for the invention are carbon fibers, which includes fibers of nanotubes or carbon nanotubes (CNT), carbon nanofibers or graphenes; silica fibers such as glass fibers, in particular type E, R or S2; boron fibers; ceramic fibers, in particular silicon carbide fibers, boron carbide fibers, boron carbonitride fibers, silicon nitride fibers, boron nitride fibers, basalt fibers; fibers or filaments containing metals and/or their alloys; metal oxide fibers, in particular of alumina (Al₂O₃); metalized fibers such as metalized glass fibers and metalized carbon fibers or mixtures of previously cited fibers.

More particularly, these fibers can be chosen as follows:
the inorganic fibers can be chosen from: carbon fibers, carbon nanotube fibers, glass fibers, in particular type E, R or S2, boron fibers, ceramic fibers, in particular silicon carbide fibers, boron carbide fibers, boron carbonitride fibers, silicon nitride fibers, boron nitride fibers, basalt fibers, fibers or filaments containing metals and/or their alloys, fibers containing metal oxides such as Al₂O₃, metalized fibers such as metalized glass fibers and metalized carbon fibers or mixtures of previously cited fibers, and
polymer fibers, under the previously cited condition above, are chosen from:
thermohardening polymer fibers and more particularly chosen from: unsaturated polyesters, epoxy resins, vinyl esters, phenol resins, polyurethanes, cyanoacrylates and polyimides, such as bis-maleimide resins, aminoplasts resulting from the reaction of an amine such as melamine with an aldehyde such as glyoxal or formaldehyde,
thermoplastic polymer fibers,
polyamide fibers, in particular polyphthalamide fibers,
aramid fibers (such as Kevlar®) and aromatic polyamides such as those having one of the formulas: PPD.T, MPD.I, PAA and PPA, with PPD and MPD being respectively p- and m-phenylene diamine, PAA being polyarylamides and PPA being polyphthalamides,
fibers of polyamide block copolymers such as polyamide/polyether, fibers of polyarylether ketones (PAEK) such as polyetherether ketone (PEEK), polyetherketone ketone (PEKK), polyetherketoneetherketone ketone (PEKEKK).

Preferred short reinforcing fibers are short fibers chosen from: carbon fibers, including metalized fibers, glass fibers, including metalized glass fibers like E, R, S2, aramid fibers (like Kevlar®) or aromatic polyamides, polyarylether ketone (PAEK) fibers, such as polyetherether ketone (PEEK), polyetherketone ketone (PEKK) fibers, polyetherketoneetherketone ketone (PEKEKK) fibers or mixtures thereof.

More particularly, natural fibers are chosen from flax, castor, wood, sisal, kenaf, coconut, hemp and jute fibers.

Preferably, the reinforcing fibers in the composition according to the invention are chosen from glass fibers, carbon fibers, among flax fibers and mixtures thereof, and more preferably glass fibers and carbon fibers, and even more preferably glass fibers.

Advantageously, the composition of the invention also comprises at least one additive.

Regarding the additives, without being limited to these, the composition according to a preferred variant of the invention comprises more particularly, specific additives such as heat stabilizers, particularly these stabilizers are antioxidants against thermo-oxidation and/or photo-oxidation of the polymer in the thermoplastic matrix and are organic or inorganic stabilizers.

The expression “organic stabilizer” or more generally a “combination of organic stabilizers,” denotes a primary antioxidant of the phenol type, a secondary antioxidant of the phosphite type and optionally other stabilizers such as a HALS, which means hindered amine light stabilizer (for example Ciba's Tinuvin® 770), an anti-UV (for example Ciba's Tinuvin® 312), a phenol stabilizer or a stabilizer containing phosphorus. Amine antioxidants such as Crompton's Naugard® 445 or polyfunctional stabilizers such as Clariant's Nylostab® S-EED can also be used.

The organic stabilizer present can be chosen, without this list being restrictive, from among:
phenol antioxidants, for example Ciba's Irganox 245, Irganox 1010, Irganox 1098, Ciba's Irganox MD 1024, Great Lakes' Lowinox 44B25, Adeka Palmarole's ADK Stab AO-80.
stabilizers containing phosphorus, such as phosphites, for example Ciba's Irgafos® 168,
a UV absorber, such as Ciba's Tinuvin 312,
a HALS, as previously stated,
an amine type stabilizer, such as Crompton's Naugard 445, or even a hindered amine type such as Ciba's Tinuvin 770,
a polyfunctional stabilizer such as Clariant's Nylostab S-EED.

A mixture of two, or more, of these organic stabilizers can obviously be envisaged.

The expression “mineral stabilizer” denotes a stabilizer containing copper or a metal oxide as described in US2008/0146717. Examples of inorganic stabilizers include copper halides and acetates or iron oxides such as FeO, Fe₂O₃, Fe₃O₄ or a mixture thereof. Secondarily, other metals such as silver can optionally be considered, but these are known to be less effective. These compounds containing copper are typically associated with alkali metal halides, particularly potassium.

These mineral stabilizers are more particularly employed, when the structures must have improved long-term heat resistance in hot air, in particular for temperatures greater than or equal to 100-120° C., because they tend to prevent breaks in polymer chains.

More particularly, a stabilizer containing copper is understood to mean a compound comprising at least one copper atom, in particular in ionizable, ionic form, for example in the form of a complex.

The stabilizer containing copper can be chosen from copper chloride, cuprous chloride, copper bromide, cuprous bromide, copper iodide, cuprous iodide, copper acetate and cuprous acetate. Mention may be made of halides, acetates of other metals such as silver in combination with the stabilizer containing copper. These compounds containing copper are typically associated with halides of alkali metals. A well known example is the mixture of CuI and KI, where the ratio CuI:KI is typically inclusively between 1:5 to 1:15. An example of such a stabilizer is Ciba's Polyadd P201.

More details on stabilizers containing copper are found in U.S. Pat. No. 2,705,227. More recently, stabilizers containing copper such as copper complexes such as Brüggemann's Bruggolen H3336, H3337, H3373 have appeared.

Advantageously, the stabilizer containing copper is chosen from copper halides, copper acetate, copper halides or copper acetate in mixture with at least one alkali metal halide, and mixtures thereof, preferably mixtures of copper iodide and potassium iodide (CuI/KI).

The additive may also be a shock modifier, advantageously consisted by a polymer having a flexural modulus below 100 MPa measured according to standard ISO 178 and a Tg below 0° C. (measured according to standard 11357-2: 2013 at the inflexion point of the DSC thermogram), particularly a polyolefin, coupled or not with a Peba (polyether block amide) having a flexural modulus <200 MPa.

The polyolefin of the impact modifier can be functionalized or non-functionalized or be a mixture of at least one functionalized polyolefin and/or least one non-functionalized polyolefin.

The additives may also be fillers that may in particular be any filler known to the person skilled in the art in the field of thermoplastic materials. This may in be heat-conducting and/or electricity-conducting fillers, such as metal powder, powdered carbon black, carbon fibrils, carbon nanotubes (CNT), silicon carbide, boron carbonitride, boron or silicon nitride. On this subject reference can be made to application WO 2010/130930 by the Applicant.

Reinforcing fibers, whether long, short or continuous, are excluded from the additives and particularly the term “inorganic filler” excludes long, short or continuous reinforcing fibers.

The additives may also be halogen-free flame retardants, such as those described in US 2008/0274355 and in particular a metal salt chosen from a metal salt of phosphinic acid, a metal salt of diphosphinic acid, a polymer containing at least one metal salt of phosphinic acid, a polymer containing at least one metal salt of diphosphinic acid or red phosphorus, an antimony oxide, a zinc oxide, an iron oxide, a magnesium oxide or metal borates such as a zinc borate or melamine pyrophosphates and melamine cyanurates. They may also be halogenated flame retardant agents such as a brominated or polybrominated polystyrene, a brominated polycarbonate or a brominated phenol.

Advantageously, the additive is chosen from an antioxidant, a heat stabilizer, a UV absorber, a light stabilizer, a shock modifier, a lubricant, an inorganic filler, a flame retardant agent, a nucleating agent, in particular an inorganic filler such as talc, and a colorant.

The expression “other polymers” denotes any thermoplastic polymer and in particular a polyamide polymer, in particular an aliphatic, cycloaliphatic or aromatic polyamide, and that can be microcrystalline or amorphous.

The expression “non-reactive composition” means, that the composition contains a polyamide polymer whose molecular weight is no longer likely to change significantly, i.e. that its number-average molecular weight (Mn) changes by less than 50% when it is used and therefore corresponding to the final polyamide polymer of the thermoplastic matrix.

These polyamides according to composition b) are non-reactive, either because of the low level of (residual) reactive functions present, particularly with a level of said functions of <120 meq/kg, or because of the presence of the same type of terminal function at the chain end and therefore cannot react together, or by modifying and blocking said reactive functions by a monofunctional reactive component, for example for amine functions by modification reaction with a monoacid or a monoisocyanate and for carboxyl functions by reaction with a monoamine.

Advantageously, the number-average molecular weight (Mn) of said final polyamide polymer of the thermoplastic matrix of said material is preferably in a range from 6000 to 40000 g/mol, preferably from 10000 to 30000 g/mol as determined by the calculation from the level of terminal functions determined by potentiometric titration in solution and the functionality of said prepolymers or by NMR. These Mn values may correspond to inherent viscosities greater than or equal to 0.7, as determined according to standard ISO 307:2007 but by changing the solvent (use of m-cresol instead of sulfuric acid and the temperature being 20° C.).

On the contrary, the expression “reactive composition” means that the molecular weight of said reactive composition will change during its implementation because of the reaction of reactive prepolymers together by condensation or with a chain extender by polyaddition and without the elimination of volatile by-products to lead to the final polyamide polymer of the thermoplastic matrix.

1,3-BAC (or 1,3 bis(aminomethyl)cyclohexane, CAS No. 2579-20-6) is a cycloaliphatic diamine monomer obtained in particular by the hydrogenation of meta-xylene diamine (MXDA). 1,3-BAC exists in the form of two isomers, cis and trans, where CAS No. 2579-20-6 corresponds to a mixture of isomers.

1,4-BAC (or 1,4 bis(aminomethyl)cyclohexane, CAS No. 2549-07-9) is a cycloaliphatic diamine monomer obtained in particular by the hydrogenation of para-xylene diamine (PXDA). 1,4-BAC exists in the form of two isomers, cis and trans, where CAS No. 2549-07-9 corresponds to a mixture of isomers.

Advantageously, the 1,3 BAC or 1,4 BAC used in the BACT unit is a mixture of cis and trans isomers in respective proportions of 0/100 to 100/0, in particular from 75/25 to 25/75.

Advantageously, the proportion of cis isomer in the 1,3 BAC is greater than 60%, preferably greater than 70%, particularly greater than 80%, in particular greater than 90%.

Advantageously, the proportion of trans isomer in the 1,4 BAC is greater than 60%, preferably greater than 70%, particularly greater than 80%, in particular greater than 90%.

BAC and/or X can be replaced, independently of each other, up to 30 mol % by other diamines defined above, in particular by a linear or branched aliphatic diamine, a cycloaliphatic diamine or a arylaromatic diamine such as meta-xylene diamine (MXDA).

As an example, the linear or branched aliphatic diamine is chosen from 1,4-butanediamine, 1,5-pentanediamine, 2-methyl-1,5-pentanediamine (MPMD), 1,6-hexanediamine, 1,8-octanediamine (OMDA), 1,9-nonanediamine (NMDA), 2-methyl-1,8-octane-diamine (MODA), 2,2,4-trimethylhexamethylenediamine (TMHMD), 2,4,4-trimethylhexamethylenediamine (TMHMD), 5-methyl-1,9-nonanediamine, 1,11-undecanediamine, 2-butyl-2-ethyl-1,5-pentanediamine, 1,12-dodecanediamine, 1,13-tridecanediamine, 1,14-tetradecanediamine, 1,16-hexadecanediamine and 1,18-octadecanediamine.

The cycloaliphatic diamine can be chosen from isophoronediamine, norbornanedimethylamine, 4,4′-diaminodicyclohexylmethane (PACM), 2,2-(4,4′-diamino-dicyclohexyl)propane (PACP), and 3,3′-dimethyl-4,4′-diaminodicyclohexylethane (MACM).

T can be replaced up to 30 mol % by other carboxylic diacids defined above, in particular by other aromatic, aliphatic or cycloaliphatic dicarboxylic acids.

The aromatic carboxylic diacids can be chosen from naphthalenedicarboxylic acid (NDA) and isophthalic acid (IPA).

The aliphatic carboxylic diacids can be chosen from suberic acid, azelaic acid, sebacic acid, undecanedioic acid, dodecanedioic acid, brassylic acid, tetradecanedioic acid, pentadecanedioic acid, hexadecanedioic acid, octadecanedioic acid and dimerized fatty acids.

The cycloaliphatic carboxylic diacids can be chosen from cis- and/or trans-cyclohexane-1,4-dicarboxylic acid and/or cis- and/or trans-cyclohexane-1,3-dicarboxylic acid (CHDA).

BAC and/or X and/or T can be replaced, independently of each other, up to 30 mol % by lactams or aminocarboxylic acids.

The lactams and aminocarboxylic acids can be chosen from α,ω-aminononanoic acid, α,ω-aminoundecanoic acid (AUA), lauryllactam (LL) and α,ω-aminododecanoic acid (ADA).

30 mol % maximum, relative to the total sum of the BAC, X and T monomers, of replacement whether by another diamine, another diacid, a lactam or an aminocarboxylic acid or any mixture of these is possible.

Advantageously, 20 mol % maximum, relative to the total sum of the BAC, X and T monomers, of replacement whether by another diamine, another diacid, a lactam or an aminocarboxylic acid or any mixture of these is possible.

Advantageously, 10 mol % maximum, relative to the total sum of the BAC, X and T monomers, of replacement whether by another diamine, another diacid, a lactam or an aminocarboxylic acid or any mixture of these is possible.

In an advantageous embodiment, the present invention relates to one of the composition for thermoplastic material No. 1 to 12 defined below, said composition comprising a semi-crystalline polyamide polymer, optionally short reinforcing fibers, said semi-crystalline polyamide polymer comprising a BACT/XT copolyamide in the proportions defined in Table I below:

TABLE I

| | Semi-crystalline | Short | | |
|---|---|---|---|---|
| | polyamide | reinforcing | | |
| | polymer | fibers | BACT | XT |
| Composition No. | % by weight | % by weight | molar % | molar % |
| 1 | 30-100 | 0-70 | 15-90 | 10-85 |
| 2 | 30-100 | 0-70 | 20-85 | 15-80 |
| 3 | 30-100 | 0-70 | 25-85 | 15-75 |
| 4 | 40-80 | 0-70 | 15-90 | 10-85 |
| 5 | 40-80 | 0-70 | 20-85 | 15-80 |
| 6 | 40-80 | 0-70 | 25-85 | 15-75 |
| 7 | 30-100 | 20-60 | 15-90 | 10-85 |
| 8 | 30-100 | 20-60 | 20-85 | 15-80 |
| 9 | 30-100 | 20-60 | 25-85 | 15-75 |
| 10 | 40-80 | 20-60 | 15-90 | 10-85 |
| 11 | 40-80 | 20-60 | 20-85 | 5-80 |
| 12 | 40-80 | 20-60 | 25-85 | 15-78 |

Compositions 1 to 12 relate to XT from C4-C5 to C7-C8.

When X is a C6 aliphatic diamine, then the present invention relates to one of the compositions for a thermoplastic material no. 1′, 2′, 4′, 5′, 7′, 8′, 10′, 11′ defined below:

| | Semi-crystalline | | | |
|---|---|---|---|---|
| | polyamide | Short reinforcing | | |
| | polymer | fibers | BACT | XT |
| Composition No. | % by weight | % by weight | molar % | molar % |
| 1′ | 30-100 | 0-70 | 5-90 | 10-60 |
| 2′ | 30-100 | 0-70 | 20-85 | 10-40 |
| 4′ | 40-80 | 0-70 | 15-90 | 10-60 |
| 5′ | 40-80 | 0-70 | 20-85 | 10-40 |
| 7′ | 30-100 | 20-60 | 15-90 | 10-60 |
| 8′ | 30-100 | 20-60 | 20-85 | 10-40 |
| 10′ | 40-80 | 20-60 | 15-90 | 10-60 |
| 11′ | 40-80 | 20-60 | 20-85 | 10-40 |

Advantageously, compositions 1 to 12 or compositions 1′, 2′, 4′, 5′, 7′, 8′, 10′, 11′ comprise from 0 to 50% by weight of additives and/or other polymers.

Advantageously, said compositions consist of a semi-crystalline polyamide polymer, optionally short reinforcing fibers, and from 0 to 50% by weight of additives and/or other polymers, said semi-crystalline polyamide polymer comprising a BACT/XT copolyamide in the proportions defined in Table I.

Advantageously, said compositions consist of a semi-crystalline polyamide polymer, optionally short reinforcing fibers, and from 0 to 50% by weight of additives and/or other polymers, said semi-crystalline polyamide polymer consisting of a BACT/XT copolyamide in the proportions defined in Table I.

Advantageously, the proportion of additives and/or other polymers in the compositions defined above is from more than 0 to 50% by weight.

Advantageously, in the compositions defined above, X is a C4, C5 or C6 diamine, particularly C6.

The Inventors have therefore found in an unexpected manner that the compositions of the invention had better capability to crystallize, a better compromise of high Tg/low Tm and especially higher enthalpy (and therefore higher modulus when hot) than compositions of the prior art.

In an advantageous embodiment, the present invention relates to a structure as defined above, wherein said semi-crystalline polyamide polymer has a melting temperature Tm comprised from 290° C. to 340° C., preferably comprised from 300° C. to 340° C., more preferably comprised from 310° C. to 340° C., as determined according to standard ISO 11357-3 (2013).

In an advantageous embodiment, the present invention relates to a composition as defined above, wherein said semi-crystalline polyamide polymer has a glass transition temperature Tg >130° C., preferably >140° C., more preferably >150° C., determined according to standard ISO 11357-2: 2013.

Advantageously, the Tg is comprised from 130 to 180° C.

In an advantageous embodiment, the present invention relates to a structure as defined above, wherein said semi-crystalline polyamide polymer has a difference between the melting temperature and the crystallization temperature Tm−Tc<40° C., preferably <30° C., determined according to standard ISO 11357-3: 2013.

In an advantageous embodiment, the present invention relates to a composition as defined above, characterized in that the enthalpy of crystallization of the semi-crystalline polyamide polymer, measured by differential scanning calorimetry (DSC) according to standard ISO 11357-3: 2013, is greater than 40 J/g, preferably greater than 45 J/g, and even more preferably greater than 50 J/g.

In an advantageous embodiment, the present invention relates to a composition as defined above, characterized in that said semi-crystalline polyamide polymer has a melting temperature: Tm of 290° C. to 340° C. and a Tg >130° C.

In an advantageous embodiment, the present invention relates to a composition as defined above, characterized in that said semi-crystalline polyamide polymer has a melting temperature: Tm of 290° C. to 340° C. and a Tg >140° C.

In an advantageous embodiment, the present invention relates to a composition as defined above, characterized in that said semi-crystalline polyamide polymer has a melting temperature: Tm of 290° C. to 340° C. and a Tg >150° C.

In an advantageous embodiment, the present invention relates to a composition as defined above, characterized in that said semi-crystalline polyamide polymer has a melting temperature: Tm of 300° C. to 340° C. and a Tg >130° C.

In an advantageous embodiment, the present invention relates to a composition as defined above, characterized in that said semi-crystalline polyamide polymer has a melting temperature: Tm of 300° C. to 340° C. and a Tg >140° C.

In an advantageous embodiment, the present invention relates to a composition as defined above, characterized in that said semi-crystalline polyamide polymer has a melting temperature: Tm of 300° C. to 340° C. and a Tg >150° C.

In an advantageous embodiment, the present invention relates to a composition as defined above, characterized in that said semi-crystalline polyamide polymer has a melting temperature: Tm of 310° C. to 340° C. and a Tg >130° C.

In an advantageous embodiment, the present invention relates to a composition as defined above, characterized in that said semi-crystalline polyamide polymer has a melting temperature: Tm of 310° C. to 340° C. and a Tg >140° C.

In an advantageous embodiment, the present invention relates to a composition as defined above, characterized in that said semi-crystalline polyamide polymer has a melting temperature: Tm of 310° C. to 340° C. and a Tg >150° C.

In an advantageous embodiment, the present invention relates to a structure as defined above, characterized in that said semi-crystalline polyamide polymer has the following characteristics (Table II):

TABLE II

| Composition | | | | Tm-Tc | Delta |
|---|---|---|---|---|---|
| No. | Initial compositions | Tm (° C.) | Tg (° C.) | (° C.) | Hc (J/g). |
| 13 | Compositions 1 to 12 and | 290 to 340 | >130° C. | | |
| | compositions 1′, 2′, 4′, 5′, | | | | |
| | 7′, 8′, 10′, 11′ | | | | |
| 14 | Compositions 1 to 12 and | 290 to 340 | >140° C. | | |
| | compositions 1′, 2′, 4′, 5′, | | | | |
| | 7′, 8′, 10′, 11′ | | | | |
| 15 | Compositions 1 to 12 and | 290 to 340 | >150° C. | | |
| | compositions 1′, 2′, 4′, 5′, | | | | |
| | 7′, 8′, 10′, 11′ | | | | |
| 16 | Compositions 1 to 12 and | 300 to | >130° C. | | |
| | compositions 1′, 2′, 4′, 5′, | 3340 | | | |
| | 7′, 8′, 10′, 11′ | | | | |
| 17 | Compositions 1 to 12 and | 300 to 340 | >140° C. | | |
| | compositions 1′, 2′, 4′, 5′, | | | | |
| | 7′, 8′, 10′, 11′ | | | | |
| 18 | Compositions 1 to 12 and | 300 to 340 | >150° C. | | |
| | compositions 1′, 2′, 4′, 5′, | | | | |
| | 7′, 8′, 10′, 11′ | | | | |
| 19 | Compositions 1 to 12 and | 310 to 140 | >130° C. | | |
| | compositions 1′, 2′, 4′, 5′, | | | | |
| | 7′, 8′, 10′, 11′ | | | | |
| 20 | Compositions 1 to 12 and | 310 to 340 | >140° C. | | |
| | compositions 1′, 2′, 4′, 5′, | | | | |
| | 7′, 8′, 10′, 11′ | | | | |
| 21 | Compositions 1 to 12 and | 310 to 340 | >150° C. | | |
| | compositions 1′, 2′, 4′, 5′, | | | | |
| | 7′, 8′, 10′, 11′ | | | | |
| 22 | Compositions 1 to 12 and | 290 to 340 | >130° C. | <40 | |
| | compositions 1′, 2′, 4′, 5′, | | | | |
| | 7′, 8′, 10′, 11′ | | | | |
| 23 | Compositions 1 to 12 and | 290 to 340 | >140° C. | <40 | |
| | compositions 1′, 2′, 4′, 5′, | | | | |
| | 7′, 8′, 10′, 11′ | | | | |
| 24 | Compositions 1 to 12 and | 290 to 340 | >150° C. | <40 | |
| | compositions 1′, 2′, 4′, 5′, | | | | |
| | 7′, 8′, 10′, 11′ | | | | |
| 25 | Compositions 1 to 12 and | 300 to 340 | >130° C. | <40 | |
| | compositions 1′, 2′, 4′, 5′, | | | | |
| | 7′, 8′, 10′, 11′ | | | | |
| 26 | Compositions 1 to 12 and | 300 to 340 | >140° C. | <40 | |
| | compositions 1′, 2′, 4′, 5′, | | | | |
| | 7′, 8′, 10′, 11′ | | | | |
| 27 | Composition 1 to 12 and | 300 to 340 | >150° C. | <40 | |
| | compositions 1′, 2′, 4′, 5′, | | | | |
| | 7′, 8′, 10′, 11′ | | | | |
| 28 | Compositions 1 to 12 and | 310 to | >130° C. | <40 | |
| | compositions 1′, 2′, 4′, 5′, | 340° C. | | | |
| | 7′, 8′, 10′, 11′ | | | | |
| 29 | Compositions 1 to 12 and | 310 to 340 | >140° C. | <40 | |
| | compositions 1′, 2′, 4′, 5′, | | | | |
| | 7′, 8′, 10′, 11′ | | | | |
| 30 | Compositions 1 to 12 and | 310 to 340 | >150° C. | <40 | |
| | compositions 1′, 2′, 4′, 5′, | | | | |
| | 7′, 8′, 10′, 11′ | | | | |
| 31 | Compositions 1 to 12 and | 290 to 340 | >130° C. | <30 | |
| | compositions 1′, 2′, 4′, 5′, | | | | |
| | 7′, 8′, 10′, 11′ | | | | |
| 32 | Compositions 1 to 12 and | 290 to 340 | >140° C. | <30 | |
| | compositions 1′, 2′, 4′, 5′, | | | | |
| | 7′, 8′, 10′, 11′ | | | | |
| 33 | Compositions 1 to 12 and | 290 to 340 | >150° C. | <30 | |
| | compositions 1′, 2′, 4′, 5′, | | | | |
| | 7′, 8′, 10′, 11′ | | | | |
| 34 | Compositions 1 to 12 and | 300 to 340 | >130° C. | <30 | |
| | compositions 1′, 2′, 4′, 5′, | | | | |
| | 7′, 8′, 10′, 11′ | | | | |
| 35 | Compositions 1 to 12 and | 300 to 340 | >140° C. | <30 | |
| | compositions 1′, 2′, 4′, 5′, | | | | |
| | 7′, 8′, 10′, 11′ | | | | |
| 36 | Compositions 1 to 12 and | 300 to 340 | >150° C. | <30 | |
| | compositions 1′, 2′, 4′, 5′, | | | | |
| | 7′, 8′, 10′, 11′ | | | | |
| 37 | Compositions 1 to 12 and | 310 to 340 | >130° C. | <30 | |
| | compositions 1′, 2′, 4′, 5′, | | | | |
| | 7′, 8′, 10′, 11′ | | | | |
| 38 | Compositions 1 to 12 and | 310 to 340 | >140° C. | <30 | |
| | compositions 1′, 2′, 4′, 5′, | | | | |
| | 7′, 8′, 10′, 11′ | | | | |
| 39 | Compositions 1 to 12 and | 310 to 340 | >150° C. | <30 | |
| | compositions 1′, 2′, 4′, 5′, | | | | |
| | 7′, 8′, 10′, 11′ | | | | |
| 40 | Compositions 1 to 12 and | 290 to 340 | >130° C. | <40 | >40 |
| | compositions 1′, 2′, 4′, 5′, | | | | |
| | 7′, 8′, 10′, 11′ | | | | |
| 41 | Compositions 1 to 12 and | 290 to 340 | >140° C. | <40 | >40 |
| | compositions 1′, 2′, 4′, 5′, | | | | |
| | 7′, 8′, 10′, 11′ | | | | |
| 42 | Compositions 1 to 12 and | 290 to 340 | >150° C. | <40 | >40 |
| | compositions 1′, 2′, 4′, 5′, | | | | |
| | 7′, 8′, 10′, 11′ | | | | |
| 43 | Compositions 1 to 12 and | 300 to 340 | >130° C. | <40 | >40 |
| | compositions 1′, 2′, 4′, 5′, | | | | |
| | 7′, 8′, 10′, 11′ | | | | |
| 44 | Compositions 1 to 12 and | 300 to 340 | >140° C. | <40 | >40 |
| | compositions 1′, 2′, 4′, 5′, | | | | |
| | 7′, 8′, 10′, 11′ | | | | |
| 45 | Compositions 1 to 12 and | 300 to 340 | >150° C. | <40 | >40 |
| | compositions 1′, 2′, 4′, 5′, | | | | |
| | 7′, 8′, 10′, 11′ | | | | |
| 46 | Compositions 1 to 12 and | 310 to 340 | >130° C. | <40 | >40 |
| | compositions 1′, 2′, 4′, 5′, | | | | |
| | 7′, 8′, 10′, 11′ | | | | |
| 47 | Compositions 1 to 12 and | 310 to 340 | >140° C. | <40 | >40 |
| | compositions 1′, 2′, 4′, 5′, | | | | |
| | 7′, 8′, 10′, 11′ | | | | |
| 48 | Compositions 1 to 12 and | 310 to 340 | >150° C. | <40 | >40 |
| | compositions 1′, 2′, 4′, 5′, | | | | |
| | 7′, 8′, 10′, 11′ | | | | |
| 49 | Compositions 1 to 12, and | 290 to 340 | >130° C. | <30 | >40 |
| | compositions 1′, 2′, 4′, 5′, | | | | |
| | 7′, 8′, 10′, 11′ | | | | |
| 50 | Compositions 1 to 12 and | 290 to 340 | >140° C. | <30 | >40 |
| | compositions 1′, 2′, 4′, 5′, | | | | |
| | 7′, 8′, 10′, 11′ | | | | |
| 51 | Compositions 1 to 12 and | 290 to 340 | >150° C. | <30 | >40 |
| | compositions 1′, 2′, 4′, 5′, | | | | |
| | 7′, 8′, 10′, 11′ | | | | |
| 52 | Compositions 1 to 12 and | 300 to 340 | >130° C. | <30 | >40 |
| | compositions 1′, 2′, 4′, 5′, | | | | |
| | 7′, 8′, 10′, 11′ | | | | |
| 53 | Compositions 1 to 12 and | 300 to 340 | >140° C. | <30 | >40 |
| | compositions 1′, 2′, 4′, 5′, | | | | |
| | 7′, 8′, 10′, 11′ | | | | |
| 54 | Compositions 1 to 12 and | 300 to 340 | >150° C. | <30 | >40 |
| | compositions 1′, 2′, 4′, 5′, | | | | |
| | 7′, 8′, 10′, 11′ | | | | |
| 55 | Compositions 1 to 12 and | 310 to 340 | >130° C. | <30 | >40 |
| | compositions 1′, 2′, 4′, 5′, | | | | |
| | 7′, 8′, 10′, 11′ | | | | |
| 56 | Compositions 1 to 12 and | 310 to 340 | >140° C. | <30 | >40 |
| | compositions 1′, 2′, 4′, 5′, | | | | |
| | 7′, 8′, 10′, 11′ | | | | |
| 57 | Compositions 1 to 12 and | 310 to 340 | >150° C. | <30 | >40 |
| | compositions 1′, 2′, 4′, 5′, | | | | |
| | 7′, 8′, 10′, 11′ | | | | |
| 58 | Compositions 1 to 12 and | 290 to 340 | >130° C. | <40 | >45 |
| | compositions 1′, 2′, 4′, 5′, | | | | |
| | 7′, 8′, 10′, 11′ | | | | |
| 59 | Compositions 1 to 12 and | 290 to 340 | >140° C. | <40 | >45 |
| | compositions 1′, 2′, 4′, 5′, | | | | |
| | 7′, 8′, 10′, 11′ | | | | |
| 60 | Compositions 1 to 12 and | 290 to 340 | >150° C. | <40 | >45 |
| | compositions 1′, 2′, 4′, 5′, | | | | |
| | 7′, 8′, 10′, 11′ | | | | |
| 61 | Compositions 1 to 12 and | 300 to 340 | >130° C. | <40 | >45 |
| | compositions 1′, 2′, 4′, 5′, | | | | |
| | 7′, 8′, 10′, 11′ | | | | |
| 62 | Compositions 1 to 12 and | 300 to 340 | >140° C. | <40 | >45 |
| | compositions 1′, 2′, 4′, 5′, | | | | |
| | 7′, 8′, 10′, 11′ | | | | |
| 63 | Compositions 1 to 12 and | 300 to 340 | >150° C. | <40 | >45 |
| | compositions 1′, 2′, 4′, 5′, | | | | |
| | 7′, 8′, 10′, 11′ | | | | |
| 64 | Compositions 1 to 12 and | 310 to 340 | >130° C. | <40 | >45 |
| | compositions 1′, 2′, 4′, 5′, | | | | |
| | 7′, 8′, 10′, 11′ | | | | |
| 65 | Compositions 1 to 12 and | 310 to 340 | >140° C. | <40 | >45 |
| | compositions 1′, 2′, 4′, 5′, | | | | |
| | 7′, 8′, 10′, 11′ | | | | |
| 66 | Compositions 1 to 12 and | 310 to 340 | >150° C. | <40 | >45 |
| | compositions 1′, 2′, 4′, 5′, | | | | |
| | 7′, 8′, 10′, 11′ | | | | |
| 67 | Compositions 1 to 12 and | 290 to 340 | >130° C. | <30 | >45 |
| | compositions 1′, 2′, 4′, 5′, | | | | |
| | 7′, 8′, 10′, 11′ | | | | |
| 68 | Compositions 1 to 12 and | 290 to 340 | >140° C. | <30 | >45 |
| | compositions 1′, 2′, 4′, 5′, | | | | |
| | 7′, 8′, 10′, 11′ | | | | |
| 69 | Compositions 1 to 12 and | 290 to 340 | >150° C. | <30 | >45 |
| | compositions 1′, 2′, 4′, 5′, | | | | |
| | 7′, 8′, 10′, 11′ | | | | |
| 70 | Compositions 1 to 12 and | 300 to 340 | >130° C. | <30 | >45 |
| | compositions 1′, 2′, 4′, 5′, | | | | |
| | 7′, 8′, 10′, 11′ | | | | |
| 71 | Compositions 1 to 12 and | 300 to $40 | >140° C. | <30 | >45 |
| | compositions 1′, 2′, 4′, 5′, | | | | |
| | 7′, 8′, 10′, 11′ | | | | |
| 72 | Compositions 1 to 12 and | 300 to 340 | >150° C. | <30 | >45 |
| | compositions 1′, 2′, 4′, 5′, | | | | |
| | 7′, 8′, 10′, 11′ | | | | |
| 73 | Compositions 1 to 12 | 310 to 340 | >130° C. | <30 | >45 |
| | compositions 1′, 2′, 4′, 5′, | | | | |
| | 7′, 8′, 10′, 11′ | | | | |
| 74 | Compositions 1 to 12 and | 310 to 340 | >140° C. | <30 | >45 |
| | compositions 1′, 2′, 4′, 5′, | | | | |
| | 7′, 8′, 10′, 11′ | | | | |
| 75 | compositions 1 to 12 and | 310 to 340 | >150° C. | <30 | >45 |
| | compositions 1′, 2′, 4′, 5′, | | | | |
| | 7′, 8′, 10′, 11′ | | | | |
| 76 | Compositions 1 to 12 and | 290 to 340 | >130° C. | <40 | >50 |
| | compositions 1′, 2′, 4′, 5′, | | | | |
| | 7′, 8′, 10′, 11′ | | | | |
| 77 | Compositions 1 to 12 and | 290 to 340 | >140° C. | <40 | >50 |
| | compositions 1′, 2′, 4′, 5′, | | | | |
| | 7′, 8′, 10′, 11′ | | | | |
| 78 | Compositions 1 to 12 and | 290 to 340 | >150° C. | <40 | >50 |
| | compositions 1′, 2′, 4′, 5′, | | | | |
| | 7′, 8′, 10′, 11′ | | | | |
| 79 | Compositions 1 to 12 and | 300 to 340 | >130° C. | <40 | >50 |
| | compositions 1′, 2′, 4′, 5′, | | | | |
| | 7′, 8′, 10′, 11′ | | | | |
| 80 | Compositions 1 to 12 and | 300 to 340 | >140° C. | <40 | >50 |
| | compositions 1′, 2′, 4′, 5′, | | | | |
| | 7′, 8′, 10′, 11′ | | | | |
| 81 | Compositions 1 to 12 and | 300 to 340 | >150° C. | <40 | >50 |
| | compositions 1′, 2′, 4′, 5′, | | | | |
| | 7′, 8′, 10′, 11′ | | | | |
| 82 | Compositions 1 to 12 and | 310 to 340 | >130° C. | <40 | >50 |
| | compositions 1′, 2′, 4′, 5′, | | | | |
| | 7′, 8′, 10′, 11′ | | | | |
| 83 | Compositions 1 to 12 and | 310 to 340 | >140° C. | <40 | >50 |
| | compositions 1′, 2′, 4′, 5′, | | | | |
| | 7′, 8′, 10′, 11′ | | | | |
| 84 | Compositions 1 to 12 and | 310 to 340 | >150° C. | <40 | >50 |
| | compositions 1′, 2′, 4′, 5′, | | | | |
| | 7′, 8′, 10′, 11′ | | | | |
| 85 | compositions 1 to 12 and | 290 to 340 | >130° C. | <30 | >50 |
| | compositions 1′, 2′, 4′, 5′, | | | | |
| | 7′, 8′, 10′, 11′ | | | | |
| 86 | Compositions 1 to 12 and | 290 to 340 | >140° C. | <30 | >50 |
| | compositions 1′, 2′, 4′, 5′, | | | | |
| | 7′, 8′, 10′, 11′ | | | | |
| 87 | Compositions 1 to 12 and | 290 to 340 | >150° C. | <30 | >50 |
| | compositions 1′, 2′, 4′, 5′, | | | | |
| | 7′, 8′, 10′, 11′ | | | | |
| 88 | Compositions 1 to 12 and | 300 to 340 | >130° C. | <30 | >50 |
| | compositions 1′, 2′, 4′, 5′, | | | | |
| | 7′, 8′, 10′, 11′ | | | | |
| 89 | Compositions 1 to 12 and | 300 to 340 | >140° C. | <30 | >50 |
| | compositions 1′, 2′, 4′, 5′, | | | | |
| | 7′, 8′, 10′, 11′ | | | | |
| 90 | Compositions 1 to 12 and | 300 to 340 | >150° C. | <30 | >50 |
| | compositions 1′, 2′, 4′, 5′, | | | | |
| | 7′, 8′, 10′, 11′ | | | | |
| 91 | Compositions 1 to 12 and | 310 to 340 | >130° C. | <30 | >50 |
| | compositions 1′, 2′, 4′, 5′, | | | | |
| | 7′, 8′, 10′, 11′ | | | | |
| 92 | Compositions 1 to 12 and | 310 to 340 | >140° C. | <30 | >50 |
| | compositions 1′, 2′, 4′, 5′, | | | | |
| | 7′, 8′, 10′, 11′ | | | | |
| 93 | Compositions 1 to 12 and | 310 to 340 | >150° C. | <30 | >50 |
| | compositions 1′, 2′, 4′, 5′, | | | | |
| | 7′, 8′, 10′, 11′ | | | | |

In an advantageous embodiment, the present invention relates to a composition as defined above, characterized in that the BAC is 1,3 BAC.

Advantageously, 1,3 BAC is a mixture of cis and trans isomers in a respective proportion of 0/100 to 100/0, in particular from 75/25 to 25/75.

Advantageously, the proportion of cis isomer in the 1,3 BAC is greater than 60%, preferably greater than 70%, particularly greater than 80%, in particular greater than 90%.

In an advantageous embodiment, the present invention relates to a composition as defined above, wherein the BAC is 1,3 BAC and XT is chosen from 4 T, 5 T and 6 T, more preferably 6 T.

Advantageously, XT is 10 T, 10 corresponding to 1,10 decanediamine.

In an advantageous embodiment, the present invention relates to a composition as defined above, wherein the sum of the monomers that replace terephthalic acid, BAC and X is equal to 0. In this latter embodiment, there is therefore no more possible substitution of the monomers in compositions 1 to 93 as defined above.

In an advantageous embodiment, the present invention relates to a composition as defined above, characterized in that said semi-crystalline polyamide polymer is a non-reactive composition according to b).

This means that said composition is the same as that of the polymer (polyamide) of the matrix of said thermoplastic material because there is no reaction in this composition, which remains stable and unchanging in terms of molecular mass when it is heated for the implementation of the thermoplastic material of the invention. The characteristics of the polyamide polymer in this composition are the same, with Tm, Tg, Tm−Tc and Delta He as defined already above as those of the final polymer.

The polyamides according to b) are obtained by classic polycondensation reaction from monomer components that are diamines, diacids and optionally amino acids or lactams, in particular in the scope of substitution of monomers.

In an advantageous embodiment, the present invention relates to a composition as defined above, characterized in that said polyamide composition is a reactive prepolymer composition according to a) and precursor of said polyamide polymer of said matrix of thermoplastic material.

According to reactive composition a), three possibilities can be distinguished, detailed below:

Advantageously, said composition a) comprises or consists of at least one reactive prepolymer carrying on the same chain two terminal functions X′ and Y′, functions that respectively reactive together by condensation, with X′ and Y′ being amine and carboxyl or carboxyl and amine respectively.

The prepolymer is a reactive polyamide carrying on the same chain (i.e. on the same prepolymer) two terminal functions X′ and Y′ functions that react together respectively by condensation.

This condensation (or polycondensation) reaction may cause the elimination of by-products. These can be eliminated by working preferably according to a process that uses open mold technology. In the case of process with a closed mold, a step of degassing, preferably under vacuum, the by-products eliminated by the reaction is present, to prevent the formation of microbubbles of by-products in the final thermoplastic material, which (the microbubbles) may affect the mechanical performances of said material if they are not eliminated here.

The term “reactive” therefore means that the Mn of the prepolymer changes by more than 50% after reaction itself or with another prepolymer or by chain extension.

After condensation, the characteristics of the final polyamide polymer obtained in this composition are the same, with Tm, Tg, Tm−Tc and Delta He as defined above already.

Advantageously, said reactive composition a) comprises at least two polyamide prepolymers that react together and each carry respectively two identical terminal functions X′ or Y′, where said function X′ of a prepolymer can react only with said function Y′ of the other prepolymer, particularly by condensation, more particularly with X′ and Y′ being amine and carboxyl or carboxyl and amine respectively.

In the same manner, this condensation (or polycondensation) reaction may cause the elimination of by-products that may be eliminated as defined above.

After condensation, the characteristics of the final polyamide polymer obtained in this composition are the same, with Tm, Tg, Tm−Tc and Delta He as defined above already.

Advantageously, said composition a) or precursor composition, comprises or consists of:
a1) at least one prepolymer of said thermoplastic polyamide polymer, bearing n reactive terminal functions X′, chosen from: —NH₂, —CO₂H and —OH, preferably NH₂ and —CO₂H with n being from 1 to 3, preferably from 1 to 2, more preferably 1 or 2, more particularly 2
   a2) at least one chain extender Y-A′-Y, with A′ being a hydrocarbon bisubstituent, with non-polymeric structure, bearing 2 identical terminal reactive functions Y, reactive by polyaddition with at least one function X′ of said prepolymer a1), preferably having a molecular mass less than 500, more preferably less than 400.

Examples of suitable extenders a2) as a function of the X′ functions carried by said semi-crystalline polyamide prepolymer a1) include the following:
when X′ is NH₂ or OH, preferably NH₂:
   either chain extender Y-A′-Y corresponds to
      Y chosen from groups: maleimide, optionally blocked isocyanate, oxazinone, oxazolinone and epoxy,
   and
      A′ is a hydrocarbon spacer optionally comprising one or more heteroatoms, and connecting the Y functions, particularly A′ is a hydrocarbon spacer or a carbon substituent bearing the functions or reactive groups Y, chosen from:
         a covalent bond between two functions (groups) Y in the case where Y=oxazinone and oxazolinone or
         an aliphatic hydrocarbon chain or an aromatic and/or cycloaliphatic hydrocarbon chain, the latter two comprising at least one ring with 5 or 6 carbon atoms optionally substituted, with optionally said aliphatic hydrocarbon chain having optionally a molecular weight of 14 to 400 g·mol⁻¹
   or chain extender Y-A′-Y corresponds to Y being a caprolactam group and A′ being able to be a carbonyl substituent such as carbonyl biscaprolactam or A′ being able to be a terephthaloyl or an isophthaloyl,
   or said chain extender Y-A′-Y carries a cyclic anhydride group Y and preferably this extender is chosen from a carboxylic cycloaliphatic and/or aromatic dianhydride and more preferably is chosen from: ethylenetetracarboxylic dianhydride, pyromellitic dianhydride, 3,3′,4,4′-biphenyltetracarboxylic dianhydride, 1,4,5,8-naphthalenetetracarboxylic dianhydride, perylenetetracarboxylic dianhydride, 3,3′,4,4′-benzophenone tetracarboxylic dianhydride, 1,2,3,4-cyclobutanetetracarboxylic dianhydride, hexafluoroisopropylidene bisphthalic dianhydride, 9,9-bis(trifluoromethyl)xanthenetetracarboxylic dianhydride, 3,3′,4,4′-diphenylsulfonetetracarboxylic dianhydride, bicyclo[2.2.2]oct-7-ene-2,3,5,6-tetracarboxylic dianhydride, 1,2,3,4-cyclopentanetetracarboxylic dianhydride, 3,3′,4,4′-diphenyl ether tetracarboxylic dianhydride or mixtures thereof
      and
when X′ is COOH:
   said chain extender Y-A′-Y corresponds to:
      Y chosen from the groups: epoxy, oxazoline, oxazine, imidazoline or aziridine, like 1,1′-iso- or tere-phthaloyl-bis (2-methyl aziridine)
      A′ being a carbon spacer (substituent) as defined above.

More particularly, when in said extender Y-A′-Y, said function Y is chosen from oxazinone, oxazolinone, oxazine, oxazoline or imidazoline, in this case, in the chain extender represented by Y-A′-Y, A′ may represent an alkylene such as —(CH₂)ₘ— where m ranges from 1 to 14 and preferably from 2 to 10 or A′ may represent a cycloalkylene and/or a substituted (alkyle) or unsubstituted arylene, like benzene arylenes, such as o-, m-, -p phenylenes or naphthalene arylenes and preferably A′ is an arylene and/or a cycloalkylene.

In the case of carbonyl- or terephthaloyl- or isophthaloyl-biscaprolactam as chain extender Y-A′-Y, the preferred conditions avoid the elimination of by-products, like the caprolactam during said polymerization and implementation when melted.

In the eventual case cited above where Y represents a blocked isocyanate function, this blocking can be achieved by blocking agents for the isocyanate function, like epsilon-caprolactam, methyl ethyl ketoxime, dimethyl pyrazole, di ethyl malonate.

Similarly, in the case where the extender is a dianhydride reacting with a prepolymer P(X′)n where X′=NH₂, the preferred conditions avoid any imide ring formation during the polymerization and implementation when melted.

Examples of chain extenders with reactive function Y=epoxy that are suitable for the implementation of the invention include aliphatic, cycloaliphatic or aromatic diepoxides optionally substituted. Examples of aliphatic diepoxides include diglycidyl ethers of aliphatic diols, as aromatic diepoxides diglycidyl ethers of bisphenol A such as bisphenol A diglycidyl ether (BADGE) and as cycloaliphatic diepoxides, diglycidyl ethers of cycloaliphatic diols or of hydrogenated bisphenol A. More generally, suitable examples of diepoxides according to the invention include bisphenol A diglycidyl ether (BADGE) and its hydrogenated derivative (cycloaliphatic), bisphenol F diglycidyl ether, tetrabromobisphenol A diglycidyl ether or hydroquinone diglycidyl ethers, ethylene glycol diglycidyl ether, propylene glycol diglycidyl ether, butylene glycol diglycidyl ether, neopentyl glycol diglycidyl ether, 1,4-butanediol diglycidyl ether, 1,6-hexanediol diglycidyl ether, cyclohexanedimethanol diglycidyl ether, polyethylene glycol diglycidyl ether with Mn<500, polypropylene glycol diglycidyl ether with Mn <500, polytetramethylene glycol diglycidyl ether with Mn<500, resorcinol diglycidyl ether, neopentylglycol diglycidyl ether, bisphenol A polyethylene glycol diglycidyl ether with Mn<500, bisphenol A polypropyleneglycol diglycidyl ether with Mn<500, dicarboxylic acid diglycidyl esters like the glycidyl ester of terephthalic acid or epoxidized diolefins (dienes) or fatty acids with double epoxidized ethylenic unsaturation, diglycidyl 1,2 cyclohexane dicarboxylate and mixtures of the diepoxides cited.

Examples of chain extenders carrying oxazoline or oxazine reactive functions Y suitable for the implementation of the invention include those we can refer to those referenced “A”, “B”, “C” and “D” on page 7 of application EP 0,581,642, and to methods of preparation thereof and to the modes of reaction described there. “A” in this document is bisoxazoline, “B” bisoxazine, “C” 1,3 phenylene bisoxazoline and “D” 1,4-phenylene bisoxazoline.

Examples of chain extenders with imidazoline reactive function Y suitable for implementation in the invention include those we can refer to described as (“A” to “F”) on page 7 to 8 and Table 1 of page 10 in application EP 0,739,924 and to methods of preparation thereof and to the modes of reaction described there.

Examples of chain extenders with reactive function Y=oxazinone or oxazolinone which are suitable for the implementation of the invention include those we can refer to described as references “A” to “D” on page 7 to 8 of application EP 0,581,641, and to methods of preparation thereof and to the modes of reaction described there.

Examples of suitable oxazinone (6-embered ring) and oxazolinone (5-membered ring) Y groups include Y group derivatives of: benzoxazinone oxazinone or oxazolinone, with as spacer A′ being able to be a single covalent bond with corresponding respective extenders being: bis-(benzoxazinone), bisoxazinone and bisoxazolinone. A′ may also be a C₁ to C₁₄ alkylene, preferably C₂ to C₁₀ but preferably A′ is an arylene and more particularly it may be a phenylene (substituted by Y in the 1,2 or 1,3 or 1,4 positions) or a naphtalene substituent (disubstituted by Y) or a phthaloyl (iso- or terephthaloyl) or A′ may be a cycloalkylene.

For Y functions like oxazine (6-membered ring), oxazoline (5-membered ring) and imidazoline (5-membered ring), the substituent A′ may be as described above where A′ can be a single covalent bond and with the corresponding respective extenders being: bisoxazine, bisoxazoline and bisimidazoline. A′ may also be a C₁ to C₁₄ alkylene, preferably C₂ to C₁₀. Substituent A′ is preferably an arylene and, more particularly, it may be a phenylene (substituted by Y in the 1,2 or 1,3 or 1,4 positions) or a naphthalene substituent (disubstituted by Y) or a phthaloyl (iso- or terephthaloyl) or A′ may be a cycloalkylene.

In the case where Y=aziridine (nitrogen heterocycle with 3 atoms equivalent to ethylene oxide replacing the ether —O— with —NH—), the substituent A′ may be a phthaloyl (1,1′iso- or tere-phthaloyl) with as example of extender of this type, 1,1′ isophthaloyl-bis(2-methyl aziridine).

The presence of a catalyst for the reaction between said prepolymer P(X′)n and said extender Y-A′-Y to a level ranging from 0.001 to 2%, preferably from 0.01 to 0.5% relative to the total weight of two co-reactants cited may accelerate the (poly)addition reaction and accordingly shorten the production cycle.

Depending on a more particular case of choice of said extender, A′ may represent an alkylene, such as —(CH₂)ₘ— where m ranging from 1 to 14 and preferably from 2 to 10 or represents an alkyl substituted or unsubstituted arylene, like benzene arylenes (like o-, m-, -p phenylenes) or naphthalene (with arylenes: naphthalenylenes). Preferably, A′ represents an arylene that may be benzene or naphthalene substituted or unsubstituted.

As already stated, said chain extender (a2) has a non-polymeric structure and preferably a molecular mass less than or equal to 500, more preferably less than or equal to 400.

Said reactive prepolymers of said reactive composition a), according to the three options cited above, have a number-average molecular weight Mn ranging from 500 to 10000, preferably from 1000 to 6000. All masses Mn are determined by potentiometry or NMR (Postma et al. (Polymer, 47, 1899-1911 (2006)).

In cases of reactive compositions of the invention according to definition a), said reactive prepolymers are prepared by classic polycondensation reaction between the corresponding diamine and diacid components and optionally (depending on the substitutions) amino acids or lactams. Prepolymers carrying X′ and Y′ amine and carboxyl functions on the same chain may be obtained for example by adding a combination of monomers (amino acid, diamine, diacid) having in total an equal quantity of amine and carboxyl motifs, but not conducting the reaction to complete conversion. Another way of obtaining these prepolymers carrying one function X′ and one Y′ is, for example, by combining a prepolymer carrying 2 identical functions X′=amine, with a diacid prepolymer carrying Y′: carboxyl, with a global molar level of acid functions equal to that of the starting amine functions X′.

To obtain prepolymers functionalized with identical functions (amines or carboxyl) on the same chain, having an excess of diamine (or globally, amine functions) suffices for having terminal amine functions or an excess of diacid (or globally, carboxyl functions) to have terminal carboxyl functions.

In the case of a prepolymer P(X′)n with n identical X′ functions, the functionality 1 can be obtained in the presence of a monofunctional blocking component (monoacid or monoamine depending on the nature of X′=amine or carboxyl).

Functionality n=2 can be obtained from difunctional components: diamines and diacids with an excess of one to bond X′ depending on this excess.

For n=3 for example, for a prepolymer P(X′)n, the presence of a trifunctional component is necessary, for example the presence of a triamine (one mole per chain of prepolymer) with a diamine in the reaction with a diacid. The preferred functionality for P(X′)n is n=2.

In an advantageous embodiment, the present invention relates to a composition as defined above, said composition a) or precursor composition, comprising or consisting of:
a1) at least one prepolymer of said thermoplastic polyamide polymer, bearing n reactive terminal functions X′, and
a2) at least one chain extender Y-A′-Y,
   wherein X′ is NH₂ or OH, specifically NH₂ and Y is chosen from an anhydride, specifically the tetracarboxylic dianhydride 3,3′,4,4′-benzophenone, an oxazinone, an oxazolinone and an epoxy

In an advantageous embodiment, the present invention relates to a composition as defined above, said composition a) or precursor composition, comprising or consisting of:
a1) at least one prepolymer of said thermoplastic polyamide polymer, bearing n reactive terminal functions X′, and
a2) at least one chain extender Y-A′-Y,
   wherein X′ is CO₂H and Y is chosen from an epoxy and an oxazoline.

Advantageously, X′ is CO₂H and Y-A′-Y is chosen from phenylene bis oxazolines, preferably 1,3-phenylene-bis(2-oxazoline) or 1,4-phenylene-bis(2-oxazoline) (PBO).

In an advantageous embodiment, the present invention relates to a composition as defined above, characterized in that it comprises a1) at least one amine prepolymer (carrying —NH₂), of said thermoplastic polymer of the matrix, particularly with at least 50% and more particularly with 100% of the terminal groups of said prepolymer a1) being primary amine functions —NH₂ and a2) at least one non-polymeric chain extender carrying a cyclic carboxylic anhydride group, preferably carried by an aromatic ring, having as substituent a group comprising an ethylene or acetylene unsaturation, preferably acetylene, where said carboxylic anhydride group can be an acid, ester, amide or imide form with said extender a2) being present at a level corresponding to a molar ratio a2)/(—NH₂) less than 0.36, preferably ranging from 0.1 to 0.35, more preferably ranging from 0.15 to 0.35 and even more preferably ranging from 0.15 to 0.31 and in that said thermoplastic polymer of the matrix is the product of the polymerization reaction by extending said prepolymer a1) by said extender a2).

Said reaction by the choice of components a1) and a2) and their specific molar ratio leads to a final thermoplastic polymer that is not crosslinked.

Said prepolymer a1) is carrying primary amine groups represented by —NH₂. More particularly, it must be noted that the average number of primary amine groups per molecule of prepolymer a1), in other words the average functionality of primary amine groups, may vary from 1 to 3 and preferably from 1 to 2. Specifically, the functionality of said prepolymer a1) of at least 50% of the terminal groups of said prepolymer a1) being primary amine functions —NH₂, this means that it is possible that a portion is carboxyl groups or the blocked chain-end groups without a reactive group and in this case, the average —NH₂ functionality can accordingly vary from 1 to 3 and preferably from 1 to 2.

The term “thermoplastic” in the case of the present invention means that the polymer resulting from the reaction of prepolymer a1) and extender a2) is essentially thermoplastic, which means that it contains less than 15% of its weight, preferably less than 10% of its weight and more preferably less than 5% of its weight and even more preferably 0% of its weight (within 0.5% or within 1%) of crosslinked polymers that are insoluble or infusible.

Said extender a2) can be chosen from:
anhydrides and anhydride derivatives in acid, ester, amide or imide form of ethynyl o-phthalic, methyl ethynyl o-phthalic, phenyl ethynyl o-phthalic, naphthyl ethynyl o-phthalic, 4-(o-phthaloyl ethynyl) o-phthalic or 4-(phenyl ethynyl ketone) o-phthalic, the last also being called 4-(phenyl ethynyl) trimellitic,
acids or esters or amides of ethynyl isophthalic, methyl ethynyl isophthalic, phenyl ethynyl isophthalic, naphthyl ethynyl isophthalic, 4-(o-phthaloyl ethynyl) isophthalic, 4-(phenyl ethynyl ketone) isophthalic, ethynyl terephthalic, methyl ethynyl terephthalic, phenyl ethynyl terephthalic, naphthyl ethynyl terephthalic, 4-(o-phthaloyl ethynyl) terephthalic, ethynyl benzoic, methyl ethynyl benzoic, phenyl ethynyl benzoic, naphthyl ethynyl benzoic, 4-(o-phthaloyl ethynyl) benzoic acids.

Advantageously, said extender a2) is chosen from aromatic anhydride compounds, preferably o-phthalic compounds, substituted in the 4-position of the aromatic ring by a substituent defined by a R—C═C—(R′)x- group with R being a C1-C2 alkyl or H or aryl, particularly phenyl or R is the residue of an aromatic carboxylic anhydride, preferably o-phthalic, bound to the acetylene triple bond by the carbon in the 4-position of the aromatic ring and x being equal to 0 or 1 and for x being equal to 1, R′ being a carbonyl group.

Advantageously, said extender a2) is chosen from aromatic o-phthalic anhydride compounds carrying in the 4-position a substituent group chosen from methyl ethynyl, phenyl ethynyl, 4-(o-phthaloyl) ethynyl, phenyl ethynyl ketone also called phenyl ethynyl trimellitic anhydride and preferably carrying in the 4-position a substituent group chosen from methyl ethynyl and phenyl ethynyl ketone.

Advantageously, said extender a2), as defined above and regardless of its structure, has a molecular weight less than or equal to 500, preferably less than or equal to 400.

Advantageously, the level of said extender a2), as defined above and regardless of its structure, in said polyamide polymer varies from 1 to 20%, particularly from 5 to 20%.

In an advantageous embodiment, the present invention relates to a composition as defined above, characterized in that it is a molding composition.

According to another feature, the present invention relates to a production method for a thermoplastic material, particularly for a mechanical part or a structural part containing said material, with composition as defined above, characterized in that it comprises at least one step of polymerization of at least one reactive composition a) as defined above according to the invention or a step of molding or implementing at least one non-reactive composition b) as defined above, by extrusion, injection or molding.

In an advantageous embodiment, the present invention relates to a production method for a thermoplastic material as defined above, characterized in that it comprises the following steps:
i) injection of a composition as defined above, optionally devoid of fiber reinforcement, in an open or closed mold or without mold,
ii) polymerization reaction in the case of a reactive polyamide composition a) as defined above, by the heating of said composition from step i) with chain extension, according to the case, by polycondensation reaction or by polyaddition reaction, in the mass when melted, with optionally in the case of the polycondensation, an elimination under vacuum of the condensation products when it is a closed mold, using an extraction system under vacuum, otherwise and preferably with the polycondensation being conducted in an open mold or without a mold,
iii) an implementation or molding of said composition from step i) in the case of a non-reactive polyamide composition b) to form the final part in a mold or with another implementation system and, in the case of a reactive composition a), a step of implementation by molding or by another implementation system and simultaneously with polymerization step ii).

According to another feature, the present invention relates to a semi-crystalline polyamide polymer, characterized in that it corresponds to (or is the) polymer of the thermoplastic matrix of said thermoplastic material, as defined above, said polymer being a non-reactive polymer as defined according to said composition b) or a polymer that can be obtained from a reactive composition as defined according to said composition a).

This thermoplastic polymer is by definition one of the essential components of the composition of the thermoplastic material of the present invention and therefore is part of the invention as a product bound to the present invention with the same common inventive concept faced with solving the same technical problem. The invention therefore also covers the use of said thermoplastic polymer according to the invention as thermoplastic matrix for a thermoplastic material containing a fiber reinforcement as described above.

According to yet another feature, the present invention relates to the use of a composition as defined above or of a non-reactive polymer as defined according to said composition b) or a polymer that can be obtained from a reactive composition as defined according to said composition a), for the manufacturing of mechanical or structural parts, containing said thermoplastic material, of single-layer or multiple-layer tubing, or of film

In an advantageous embodiment, the present invention relates to the use as defined above, characterized in that said mechanical or structural parts of said thermoplastic material relate to applications in the domain of automotive, rail, marine (maritime), wind power, photovoltaic, solar, including solar panels and components for solar plants, sports, aeronautics and space, road transport (relating to trucks), construction, civil engineering, signs and leisure.

According to another feature, the present invention relates to a thermoplastic material resulting from the use of at least one composition as defined above.

In another advantageous embodiment, the present invention relates to the use as defined above, characterized in that said mechanical parts for applications in automotive are under-the-hood parts for the transport of fluid, in particular in devices for air intake, cooling (for example by air, cooling liquid, etc.), for transport or transfer of fuels or fluids, in particular oil, water, etc.

In yet another advantageous embodiment, the present invention relates to the use as defined above, characterized in that said mechanical or structural parts for applications in electrical or electronics are goods for electrical and electronic equipment, such as encapsulated solenoids, pumps, telephones, computers, printers, fax machines, modems, monitors, remote controls, cameras, circuit breakers, protective tubes for electric cables, optic fibers, switches, multimedia systems.

### Methods of Determination of the Characteristics Cited

The intrinsic or inherent viscosity is measured in m-cresol. The method is well known to the person skilled in the art. Standard ISO 307:2007 is followed but changing the solvent (use of m-cresol instead of sulfuric acid and the temperature being 20° C.).
The glass transition temperature Tg is measured using a differential scanning calorimeter (DSC), after a second heating pass, according to standard ISO 11357-2:2013. The heating and cooling rates are 20° C./min.
The melting temperature Tm and the crystallization temperature Tc are measured by DSC, according to standard ISO 11357-3:2013. The heating and cooling rates are 20° C./min.
The crystallization enthalpy of said polymer matrix is measured using differential scanning calorimetry (DSC) according to standard ISO 11357-3:2013.

### EXAMPLES

A—Preparation of a Polyamide Polymer by the Direct Method (without Chain Extension)

The procedure that follows is an example of a preparation process, and is not limiting. It is representative of all the compositions according to the invention:

To a 14 liter autoclave reactor, 5 kg of the following raw materials are added:
500 g water,
the diamines,
the amino acid (optionally),
terephthalic acid and optionally one or more other diacids,
the monofunctional chain regulator: benzoic acid in a suitable quantity for the target Mn and varying (benzoic acid) from 50 to 100 g,
35 g of sodium hypophosphite in solution,
0.1 g of a WACKER AK1000 antifoam agent (from Wacker Silicones).

The nature and molar ratios of the molecular motifs and structures of the polyamides (per test referenced) are given in Table III below.

The closed reactor is purged of its residual oxygen then heated to a temperature of 230° C. relative to the material added. After 30 minutes of stirring in these conditions, the vapor that formed under pressure in the reactor is relaxed progressively over 60 minutes, while progressively increasing the material temperature so as to establish it at Tm+10° C. at atmospheric pressure.

The polymerization then continues under a nitrogen purge of 20 L/h until the target mass Mn indicated in the table of characteristics is obtained.

The polymer is then emptied through the bottom valve then cooled in a water bath then shaped into granules.

The results are shown in Tables III-IV below. These were obtained from 1,3 BAC having a cis/trans ratio of 75/25 mol %.

TABLE III

| | 6T | BACT | Tm | Tc | Tm − Tc | DeltaHc | Tg |
|---|---|---|---|---|---|---|---|
| Ref | mol % | mol % | ° C. | ° C. | ° C. | J/g | ° C. |
| C6T* | 100.0 | 0.0 | 371 | — | — | — | — |
| I1 | 25.0 | 75.0 | 306 | 272 | 34 | — | 176.0 |
| C | 0.0 | 100.0 | 349 | — | — | — | 187 |
| BACT** | | | | | | | |

C denotes Comparison
I denotes Invention
*According to Nylon Plastic Handbook (Edited by Melvin I. Kohan, 1995, p71)
**According to JP2015017177

The results in Table III show that for a molar fraction of BACT of 15 to 90 mol %, the melting temperature is comprised from 290° C. to 340° C. (preferably from 300° C. to 340° C.).

In the same period, the Tg is high >130° C.

TABLE IV

| | | Moleocular structure/ | Tm | Tc | Tm − Tc | DeltaHc | Tg | Inherent |
|---|---|---|---|---|---|---|---|---|
| Ref | Experiment type | Molar composition | ° C. | ° C. | ° C. | J/g | ° C. | viscosity |
| C1 | Comparison, | 10T/6T (59/41) | 281 | 236 | 45 | 44 | 122 | 1.12 |
| | EP1,988,113 | | | | | | | |
| C2 | Comparison, | 10T/6T/11 | 269 | 220 | 49 | 39 | 111 | 1.25 |
| | EP1,988,113 | (60/24/16) | | | | | | |
| C3 | Comparison, | 10T/TMDT | 263 | 197 | 66 | 35 | 133 | 1.15 |
| | (WO2011/00393) | (59/41) | | | | | | |
| C10T | Comparison | 10T (100) | 314 | 279 | 35 | 63 | 120 | insoluble |
| C4 | Comparison | 10T/11 (67/33) | 269 | 232 | 37 | 50 | 84 | 1.19 |
| C5 | Comparison | 10,T/11 (59/41) | 261 | 213 | 48 | 39 | 78 | 1.15 |
| C6 | Comparison | 10,T/10I (67/33) | 269 | 205 | 64 | 32 | 110 | 1.12 |
| C7 | Comparison | MXDT/11 (59/41) | 211 | (*) | >100 | 12 | 111 | 1.25 |
| C8 | Comparison | MPMDT/11 (59/41) | — | (*) | — | — | 84 | 1.14 |
| C9 | Comparison | 10T/MXDT (50/50) | 262 | 211 | 51 | 17 | 137 | 0.99 |
| C10 | Comparison | 10T/MPMDT | 264 | 219 | 45 | 40 | 126 | 1.11 |
| | | (59/41) | | | | | | |
| C11 | Comparison | 10T/MPMDT | 245 | 185 | 60 | 22 | 127 | 1.12 |
| | | (50/50) | | | | | | |
| C12 | Comparison | 10T/12T/11 | 271 | 246 | 25 | 56 | 105 | 0.98 |
| | | (60/24/16) | | | | | | |
| C13 | Comparison | 18T/MXDT (71/29) | 264 | 242 | 22 | 47 | 95 | 0.86 |
| C14 | Comparison | 1,3BACT/10T | 275.6 | 241.7 | 33.9 | 60.8 | 134.0 | 0.92 |
| | | (60/40) | | | | | | |
| C15 | Comparison | 1,3BACT/10T | 281.7 | 248.3 | 33.4 | 53.5 | 153.4 | 1.05 |
| | | (60/40) | | | | | | |
| C16 | Comparison | 1,3BACT/10T | 279.4 | 242.5 | 36.9 | 55.5 | 146.0 | 0.93 |
| | | (45/55) | | | | | | |
| C17 | Comparison | 1,3BACT/10T | 279.8 | 252.0 | 27.8 | 62.2 | 142.7 | 0.87 |
| | | (45/55) | | | | | | |
| C18 | Comparison | 1,3BACT/10T | 282.0 | 253.5 | 28.5 | 49.7 | 160.2 | 1.09 |
| | | (40/60) | | | | | | |
| C19 | Comparison | 1,3BACT/10T | 286.1 | 250.4 | 35.7 | 57.0 | 163.9 | 0.94 |
| | | (40/60) | | | | | | |

(*): No crystallization upon cooling.

The results of Table IV show that the total substitution of BAC or the 6 T motif leads to compositions that do not have at least one of the required values of Tm, Tg, Tm−Tc and delta Hc.

1. A composition for a thermoplastic material comprising:
0 to 70% by weight of short reinforcing fibers,
30 to 100% by weight of a thermoplastic matrix based on at least one semi-crystalline polyamide polymer,
0 to 50% of additives and/or other polymers,
said composition being:
a) a reactive composition comprising at least one reactive precursor polyamide prepolymer of said semi-crystalline polyamide polymer,
or as an alternative to a),
b) a non-reactive composition of at least one polyamide polymer, said composition being that of the thermoplastic matrix defined above,
and said reactive polyamide prepolymer of composition a) and said polyamide polymer of composition b) comprising at least one BACT/XT copolyamide wherein:
BACT is a unit with an amide motif present at a molar content ranging from 15 to 90%, where BAC is selected from the group consisting of 1,3-bis (aminomethyl) cyclohexane (1,3 BAC), 1,4-bis (aminomethyl) cyclohexyl (1,4 BAC) and a mixture thereof, and T is terephthalic acid,
XT is a unit with an amide motif present at a molar content ranging from 10 to 85%, where X is a C₄ to C₈ linear aliphatic diamine, and where T is terephthalic acid,
in the BACT and/or XT units, independently of each other, up to 30 mol % of terephthalic acid, relative to the total quantity of dicarboxylic acids, can be replaced by other aromatic, aliphatic dicarboxylic acids chosen from suberic acid, azelaic acid, sebacic acid, undecanedioic acid, dodecanedioic acid, brassylic acid, tetradecanedioic acid, pentadecanedioic acid, hexadecanedioic acid, octadecanedioic acid and dimerized fatty acids or cycloaliphatic acids comprising 6 to 36 carbon atoms, and
in the BACT and/or XT units, independently of each other, up to 30 mol % of BAC and/or if applicable X, relative to the total quantity of the diamines, can be replaced by other diamines comprising from 4 to 36 carbon atoms and
in the copolyamide, not more than 30 mol % relative to the total quantity of the monomers, can be formed by lactams or aminocarboxylic acids chosen from α,ω-aminononanoic acid, α,ω-aminoundecanoic acid (AUA), lauryllactam (LL) and α,ω-aminododecanoic acid (ADA), and
provided that the sum of the monomers that replace terephthalic acid, BAC and X does not exceed a concentration of 30 mol %, relative to the total quantity of the monomers used in the copolyamide, and
provided that BACT and XT units are still present in said polyamide polymer, and
provided that when X is a C₆ linear aliphatic diamine, BACT is present at a molar content ranging from 60 to 90%, and 6 T is present at a molar content ranging from 10 to 60%.

2. The composition according to claim 1, wherein said semi-crystalline polyamide polymer has a melting temperature Tm from 290° C. to 340° C., as determined according to standard ISO 11357-3 (2013).

3. The composition according to claim 1, wherein said semi-crystalline polyamide polymer has a glass transition temperature Tg>130° C. determined according to standard ISO 11357-2:2013.

4. The composition according to claim 1, wherein said semi-crystalline polyamide polymer has a difference between the melting temperature and the crystallization temperature Tm−Tc<40° C., determined according to standard ISO 11357-3:2013.

5. The composition according to claim 1, wherein the enthalpy of crystallization of the semi-crystalline polyamide polymer, measured by differential scanning calorimetry (DSC) according to standard ISO 11357-3:2013, is greater than 40 J/g.

6. The composition according to claim 1, wherein the BAC is 1,3 BAC.

7. The composition according to claim 1, wherein the BAC is 1,3 BAC and XT is chosen from 4 T, 5 T, or 6 T.

8. The composition according to claim 1, wherein XT is 10 T, 10 corresponding to 1,10 decanediamine.

9. The composition according to claim 1, wherein the sum of the monomers that replace terephthalic acid, BAC and X is equal to 0.

10. The composition according to claim 1, wherein said composition is a non-reactive composition according to b).

11. The composition according to claim 1, wherein said polyamide composition is a reactive prepolymer composition according to a) and precursor of said polyamide polymer of said matrix of the thermoplastic material.

12. The composition according to claim 1, wherein it further comprises at least one additive.

13. The composition according to claim 12, wherein the additive is selected from the group consisting of an antioxidant, a heat stabilizer, a UV absorber, a light stabilizer, a shock modifier, a lubricant, an inorganic filler, a flame retardant agent, a nucleating agent and a colorant.

14. The composition according to claim 1, wherein said composition is a molding composition.

15. A production method for a thermoplastic material, particularly for a mechanical part or a structural part containing said material, with composition as defined according to claim 1, wherein it comprises at least one step of polymerization of at least one reactive composition a) as defined above according to claim 11, or a step of molding or implementing at least one non-reactive composition b) as defined according to claim 10, by extrusion, injection or molding.

16. The method according to claim 15, wherein said method comprises the following steps:
i) injecting into an open or closed mold or without a mold, a composition according to claim 1, optionally without fibrous reinforcing,
ii) polymerizing in the case of a reactive polyamide composition a) by heating of said composition from step i) with chain extender, by a polycondensation reaction or polyaddition reaction, in bulk in the molten state, with optionally in the case of polycondensation, elimination under vacuum of condensation products when it involves a closed mold, using an extraction system under vacuum,
iii) molding of said composition from step i) in the case of a non-reactive polyamide composition b) to form a final part in a mold and, in the case of a reactive composition a), a step of molding and simultaneously with polymerization step ii).

17. A semi-crystalline polyamide polymer, wherein it corresponds to (or is the) polymer of the thermoplastic matrix of said thermoplastic material such as defined according to claim 1, said polymer being a non-reactive polymer as defined according to said composition b) or a polymer which can be obtained from a reactive composition as defined according to said composition a).

18. (canceled)

19. The mechanical or structural part of claim 23, wherein said mechanical or structural part is a material in a automotive, electrical or electronic, rail, marine, wind power, photovoltaic, solar, solar panels and components for solar plants, sports, aeronautics and space, road transport, construction, civil engineering, signs and leisure application.

20. (canceled)

21. (canceled)

22. (canceled)

23. A mechanical or structural part made of said thermoplastic material, of claim 1.

24. The part according to claim 23, wherein said part is a mechanical part in automotive selected from the group consisting of under-the-hood parts for the transport of fluid, devices for air intake, devices for cooling of fluids, devices for the cooling of air, transport or transfer of fuel, transport or tranfer of oil, and the transport or transfer of water.

25. The part according to claim 23, wherein said part is a mechanical or structural part in the electrical or electronic fields selected from the group consisting of goods for electrical or electronic equipment, encapsulated solenoids, pumps, telephones, computers, printers, fax machines, modems, monitors, remote controls, cameras, circuit breakers, protective tubes for electric cables, optic fibers, switches and multimedia systems.
